(19) United States
(12) Patent Application Publication
(10) Pub. No.: US 2011/0188126 A1
(43) Pub. Date: Aug. 4, 2011

(54) VISUAL DISPLAY APPARATUS

(75) Inventor: Takayoshi TOGINO, Koganei-shi (JP)

(73) Assignee: OLYMPUS CORPORATION, Tokyo (JP)

(21) Appl. No.: 13/022,916

(22) Filed: Feb. 8, 2011

Related U.S. Application Data
(63) Continuation of application No. PCT/JP2009/003842, filed on Aug. 10, 2009.

(30) Foreign Application Priority Data
Aug. 12, 2008 (JP) 2008-207592

(51) Int. Cl. G02B 25/00

(52) U.S. Cl. 359/643

(57) ABSTRACT

The visual display apparatus of the invention has an image display device, a projection optical system for projection of an image displayed on the image display device, an eyepiece optical system of positive reflecting power that uses an image coming from afar as an image projected from the projection optical system, and a cylindrical or conical diffusing surface located near an image projected from the projection optical system. The image projected from the projection optical system is located in such a way as to draw a circular arc at any position in the plane orthogonal to the optical axis of the projection optical system.

### BACKGROUND OF THE INVENTION

The present invention relates generally to a visual display apparatus, and more particularly to a visual display apparatus capable of displaying images over a wide observation angle of view.

Conventional optical systems so far designed to view or observe virtual images or real images include those set forth in JP(A) 10-206790, Japanese Patent No. 2916142, and U.S. Pat. Nos. 3,998,532, 4,012,126, 4,078,860 and 4,100,571.

### SUMMARY OF THE INVENTION

The present invention provides a visual display apparatus comprising an image display device, a projection optical system for projection of an image displayed on the image display device, an eyepiece optical system of positive reflecting power for using an image coming from afar as an image to be projected from the projection optical system, and a cylindrical or conical diffusing surface located near the image projected from the projection optical system, wherein the image projected from the projection optical system is located in such a way as to draw a circular arc at any position in the plane orthogonal to an optical axis of the projection optical system.

The aforesaid image display device displays an annular or arcing image.

A visual axis extending in front of a viewer or through the center of an observation angle of view crosses the optical axis of the projection optical system.

A visual axis extending in front of a viewer or through the center of an observation angle of view is orthogonal to the optical axis of the projection optical system.

The aforesaid eyepiece optical system is at a tilt to the visual axis extending in front of a viewer or through the center of an observation angle of view.

The image projected from the aforesaid projection optical system is located at a tilt to a center chief ray.

The aforesaid diffuse plane is located at a tilt to a center chief ray.

The aforesaid diffuse plane is in a linear form in the meridional section.

The aforesaid projection optical system is incapable of projecting images on an optical axis.

The aforesaid eyepiece optical system is a spherical surface.

The aforesaid eyepiece optical system is a toric surface.

The aforesaid eyepiece optical system is a part of an elliptical surface having two focuses: one defined by the exit pupil position of the aforesaid projection optical system, and the other by the eyeball position of the viewer.

The aforesaid eyepiece optical system is a free-form surface.

The aforesaid eyepiece optical system is an extended rotation free-form surface.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1 is illustrative in conception of one exemplary visual display apparatus.

FIG. 2 is a plan view of FIG. 1.

FIG. 3 is illustrative of one example of what is displayed on the image display device.

FIG. 4 is illustrative of another example of what is displayed on the image display device.

FIG. 5 is illustrative of one exemplary visual display apparatus having two projection optical systems located in association with the left and right eyeballs.

FIG. 6 is illustrative of the visual display apparatus combined with a seat.

FIG. 7 is illustrative in section of one exemplary visual display apparatus wherein the eyepiece optical system and diffusing surface are each configured into an annular shape.

FIG. 8 is illustrative of a coordinate system for one embodiment of the visual display apparatus.

FIG. 9 is illustrative of the definition of the extended rotation free-form surface.

FIG. 10 is illustrative in section of the visual display apparatus according to Example 1 as taken along the optical axis.

FIG. 11 is a plan view of FIG. 10.

FIG. 12 is illustrative in section of the visual display apparatus according to Example 2 as taken along the optical axis.

FIG. 13 is a plan view of FIG. 12.

FIG. 14 is illustrative in section of the visual display apparatus according to Example 3 as taken along the optical axis.

FIG. 15 is a plan view of FIG. 14.

FIG. 16 is illustrative in section of the visual display apparatus according to Example 4 as taken along the optical axis.

FIG. 17 is a plan view of FIG. 16.

### DESCRIPTION OF EXEMPLARY EMBODIMENTS

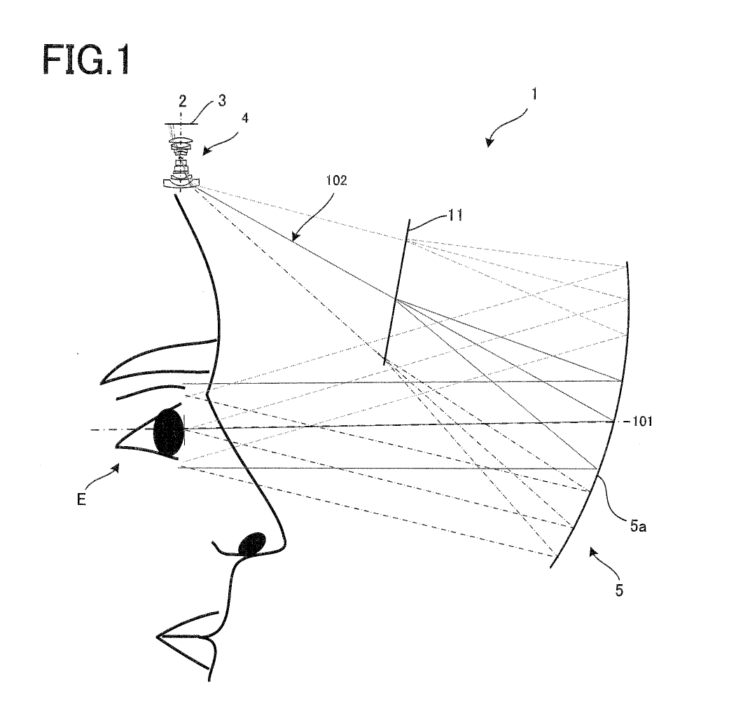

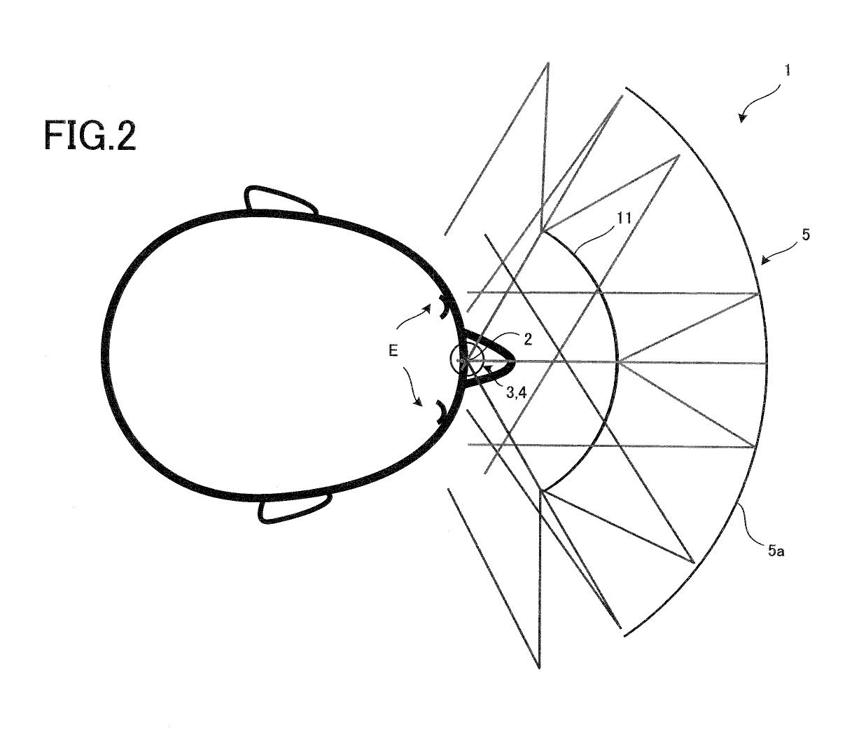

The inventive visual display apparatus is now explained with reference to several examples. FIG. 1 is illustrative in conception of the visual display apparatus 1, and FIG. 2 is a plan view of FIG. 1.

As shown in FIGS. 1 and 2, the visual display apparatus 1 is built up of an image display device 3, a projection optical system 4 for projecting an image displayed on the image display device 3, an eyepiece optical system 5 of positive reflecting power for using an image coming from afar as the image to be projected from the projection optical system 4, and a cylindrical or conical diffusing surface 11 located near an image projected from the projection optical system 4, wherein the image projected from the projection optical system 4 is located in such a way as to draw a circular arc in the plane orthogonal to the optical axis 2 of the projection optical system 4.

Albeit being of small size, this arrangement allows for clear viewing of images over a wide angle of view.

So far, there has been an arrangement wherein a relay optical system is used to relay an image on a small-sized display device to the front focal position of an eyepiece optical system so that the eyepiece optical system can provide images over a wide observation angle of view. To obtain wide-angle observation images, however, it is necessary to make a combined focal length of the projection and eyepiece optical systems very short. This means that to obtain a wide exit pupil at the eyepiece optical system, it is necessary for the NA of the projection optical system on the image display device side to have a very large value, offering a problem that the projection optical system becomes complicated, and grows bulky.

If the diffusing surface 11 of diffusion capability is located near the image plane of the projection optical system 4 to diffuse projected images at that diffusing surface 11, it is then possible to make the entrance pupil of the eyepiece optical system 5 large, so much so that the viewer can view images constantly even when there is a little movement.

On the other hand, there is tight field curvature occurring at the eyepiece optical system 5 capable of providing an ever wider observation angle of view. It is here of importance that the projection surface be located in such a way as to draw a circular arc at any position in the plane orthogonal to the optical axis of the projection optical system 4, although bending the projection surface along that field curvature has already been put forward in the art.

Especially when the observation angle of view is greater than 45 degrees, the field curvature of the eyepiece optical system 5 will grow greater than 45 degrees too. As field curvature having a circular arc angle of greater than 45 degrees takes place at the projection optical system 4, it will render it impossible to make the projection optical system 4 compact because of too much load on it. Therefore, if the projection optical system 4 is designed such that as an image is projected, it describes a circular arc in the plane orthogonal to the optical axis 2 of the projection optical system 4, it is then possible to use an image plane of this arc portion as an intermediate image for the eyepiece optical system 5, thereby successfully canceling out such large field curvature.

When an image is viewed by both the left and right eyes, the diffusing surface 11 should preferably be configured into a cylindrical or conical shape. This is the condition necessary for keeping the vergence of both eyes of the viewer constant, meaning that the diffusing surface 11, if it is of spherical shape, will cause a distance from a concave mirror to change depending on the vertical angle of view of an image under observation, departing from the range where the image can be integrated by both eyes, so resulting in a double image.

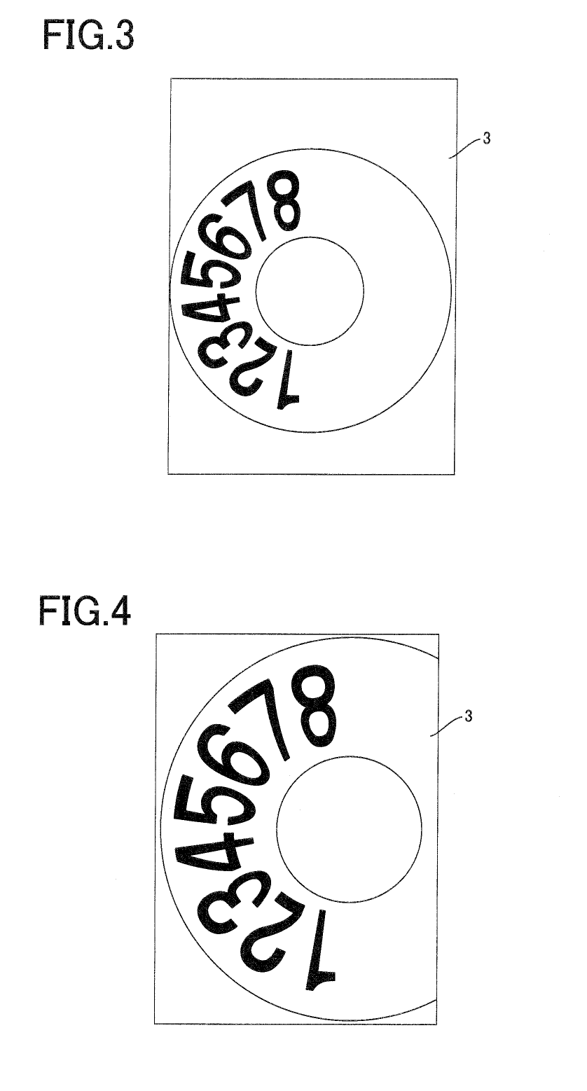

As shown in FIGS. 3 and 4, the image display device 3 should preferably display an annular or arcing image.

For the invention designed to project surrounding images through the projection optical system 4 onto the eyepiece optical system 5, it is necessary for the displayed image to be commensurate with this too. To this end, it is necessary to display an annular or arcing image with its center direction lying below the image to be viewed, as shown in FIGS. 3 and 4. Although depending on the type of the projection optical system 4, it is necessary to display an annular or arcing image with its center direction lying above the image to be viewed.

Typically for a 240° arrangement where images in the rear of the viewer are not to be displayed, it is more preferable to display observation images in a substantially semi-circular configuration so as to make more effective use of the pixels of the display device; for instance when images at 120 degrees are to be displayed, it is preferable to display them in a fanlike configuration. As shown in FIG. 4, it is also preferable that only viewable portions of an annular or arcing display image are enlarged and displayed so as to make more effective use of the pixels of the image display device 3.

In a preferable embodiment of the invention, a visual axis 101 extending in front of the viewer or through the center of the observation angle of view should cross the optical axis 2 of the projection optical system 4.

The projection surface of the projection optical system 4 is constructed such that an image projected in such a way as to draw a circular arc in the plane orthogonal at any position to the optical axis 2 of the projection optical system 4, i.e., an image projected in a cylindrical configuration about the optical axis 2 of the projection optical system 4 is enlarged through the eyepiece optical system 5; in other words, any observation image cannot be formed by a conventional method of bringing the optical axis 2 of the projection optical system 4 in alignment with the optical axis of the eyepiece optical system 5. Here, if the optical axis 2 of the projection optical system 4 is arranged in such as way as to cross the visual axis 101, it is then possible to view the image projected about the optical axis 2 of the projection optical system 4 through the eyepiece optical system 5.

In a preferable embodiment of the invention, the visual axis 101 extending in front of the viewer or through the center of the observation angle of view should be orthogonal to the optical axis 2 of the projection optical system 4.

Making the visual axis 101 orthogonal to the optical axis 2 of the projection optical system 4 causes a circle of any arbitrary height on the image display device 3 to be in alignment with the horizontal direction including the visual axis 101 of the observation image, effectively reducing image distortion.

In a preferable embodiment of the invention, the eyepiece optical system 5 should be located at a tilt to the visual axis 101 extending in front of the viewer or through the center of the observation angle of view.

Locating the eyepiece optical system 5 at a tilt to the visual axis 101 makes it possible to mount the projection optical system 4 overhead, eschewing interference of the head of the viewer with the projection optical system 4.

In a preferable embodiment of the invention, the image projected from the projection optical system 4 should be located at a tilt to a center chief ray 102. It is here to be noted that a part of the center chief ray 102 is in alignment with the visual axis 101.

Because the eyepiece optical system 5 is located at a tilt, the object plane of the eyepiece optical system 5, too, will tilt by reason of decentration aberrations. Conversely, if the projection surface is located at the tilting object plane and the image projected from the projection optical system 4 is formed on that plane, it is then possible to display the observation image as a virtual image at a predetermined distance.

In a preferable embodiment of the invention, the diffusing surface 11 should be located at a tilt to the center chief ray 102.

The reason is that when the projection surface is located at a tilt to the center chief ray 102, the observation image will blur unless the diffusing surface 11 is in alignment with the image plane. More preferably, the tilt angle should be the same too.

In a preferable embodiment of the invention, the diffusing surface 11 should be in a linear configuration in the meridional section.

The image projected onto the diffusing surface 11 is diffused and reflected at the eyepiece optical system 5, then arriving at the viewer s left and right eyes. As the shape of the image projected onto the diffusing surface is curved in the meridional section, however, it causes the angle of vergence of rays incident on both eyes of the viewer to differ in the vertical direction of the observation screen, so it cannot be integrated by both eyes: it looks like a double image. For fabrication, it is more preferable that the projection surface is configured in a cylindrical form, and so is the diffusing surface 11.

In a preferable embodiment of the invention, the projection optical system should be incapable of projecting images on the optical axis.

The primary object of the inventive apparatus is to present images outside and off the optical axis 2 of the projection optical system 4 to the viewer through the eyepiece optical system 5; images on the optical axis 2 must be inessential. The images on that optical axis 2 become inessential light that will be an obstacle to observation, and cause a lowering of contrast of the observation image. In other words, it is preferable for the images on the optical axis 2 to be not displayed whatsoever. More preferably, light rays on the optical axis 2 should be shielded off by a block member or the like. Even more preferably, light rays reflected and diffused at the diffusing surface 11 and entering directly the viewer s eyes not via the eyepiece optical system 5, too, should be shielded off by the block member because clearer observation images can then be obtained.

In a preferable embodiment of the invention, the eyepiece optical system 5 should be a spherical surface.

If the eyepiece optical system 5 is made up of a spherical surface, it is then possible to make use of an existing plastic spherical lens so that productivity can be boosted up at lower production costs. The reflecting surface of the concave mirror may be made up of either the inside surface of the plastic spherical lens into a front-surface mirror or the outside surface of the plastic spherical lens into a back-surface mirror.

In a preferable embodiment of the invention, the eyepiece optical system 5 should be a toric surface.

If the eyepiece optical system 5 is made up of a toric surface, it is then possible to rid the eyepiece optical system 5 of pupil aberrations in general, and astigmatism in particular. This in turn makes it possible to keep the diffusion capability of the diffusing surface 11 so low that brighter observation images can be viewed. It is also possible to dim out a light source for illuminating the image display device 3, thereby obtaining brighter observation images at lower power consumptions.

In a preferable embodiment of the invention, the eyepiece optical system 5 should be a part of an elliptical surface having two focuses: one defined by the exit pupil position of the projection optical system 4, and the other by the eyeball position of the viewer.

Configuring the eyepiece optical system 5 into an ellipse holds back pupil aberrations, having much the same effect as the tonic surface.

In a preferable embodiment of the invention, the eyepiece optical system 5 should be a free-form surface.

Use of the free-form surface enables the eyepiece optical system 5 to have reduced field curvature. Especially, this is effective for an arrangement having a narrow angle of view.

In a preferable embodiment of the invention, the eyepiece optical system 5 should be an extended rotation free-form surface.

Use of the extended rotation free-form surface makes it possible to reduce the field curvature in the meridional section (in the vertical section) of the eyepiece optical system 5. Especially, this is effective for an arrangement having a wide angle of view.

For the projection optical system 5 a wide-angle fisheye lens may also be used. For instance, use may be made of not only the first example set forth in JP(B) 2-14684, but also a general fisheye lens. In any event, it is important that the exit pupil of the projection optical system 4 be in alignment with the entrance pupil of the eyepiece optical system 5.

The projection optical system 4 may also be assembled of one convex mirror and an ordinary projection optical system 4.

More preferably, use is made of a fisheye lens having F-θ characteristics capable of reducing distortion, because a so-called fisheye lens has distortion such that images around the image of interest are seen small.

Even more preferably, the diffusing plate set forth in JP(A) 2004-102204 filed by Applicant should be used for the diffusing surface 11.

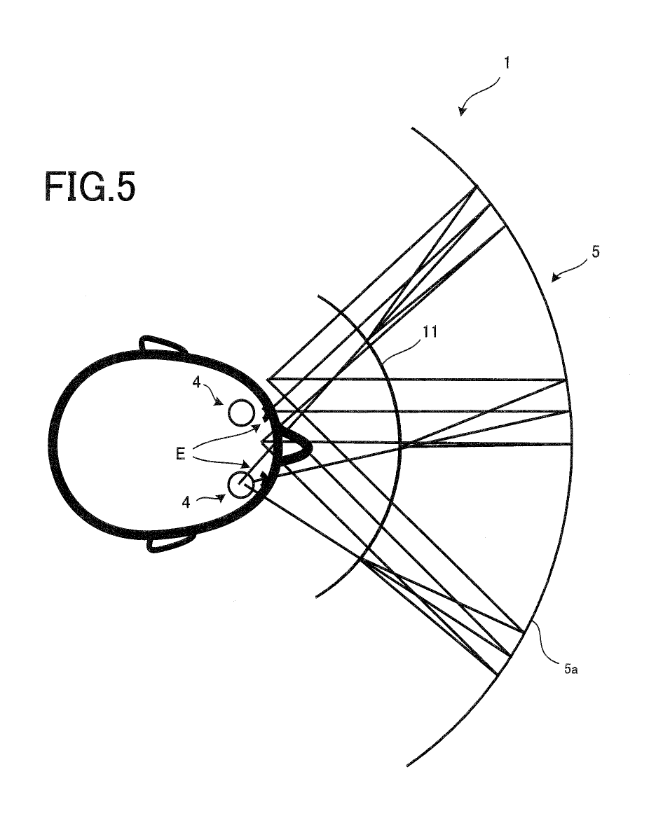

Even more preferably, two projection optical systems 4 corresponding to the left and right eyeballs (entrance pupils) E should be located, as shown in FIG. 5. At the same time as images projected from both projection optical systems 4 are projected onto the diffusing surface 11, the angle of diffusion of the diffusing surface 11 is controlled in such a way as to prevent crosstalk of the two images whereby a 3D image can be observed.

If the diffusing surface 11 is holographically processed, it is then possible to eschew a problem that the diffusing surface 11 is seen as such.

The above problem could also be solved by rotating or vibrating the diffusing surface 11. Further, if the eyepiece optical system 5 is configured as a semi-transmitting surface, it is then possible to set up a so-called combiner capable of displaying external images and an electronic image in a superposed fashion. Preferably in this case, a holographic device should be applied to an annular substrate to set up a combiner also serving as a concave mirror.

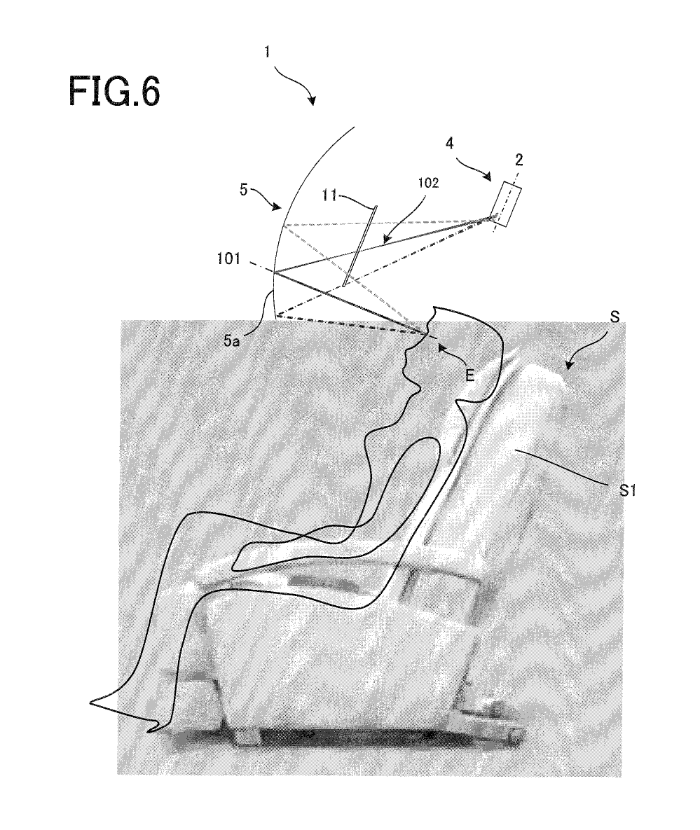

FIG. 6 is illustrative of the visual display apparatus 1 combined with a seat S. The seat S is a sofa or one for vehicles or the like, and the visual display apparatus 1 is located and angled in association with the angle of the back portion S1 of the seat S. Preferably, the seat S should have a reclining mechanism, and the visual display apparatus 1 should be angled in association with the angle of the back portion S1 reclined by the reclining mechanism.

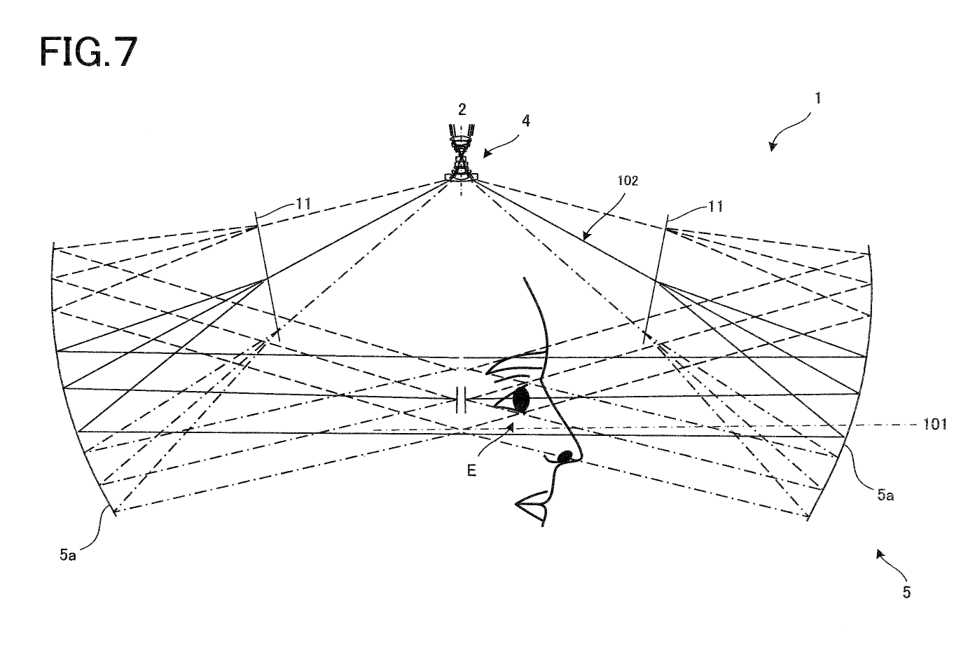

FIG. 7 is illustrative in section of the visual display apparatus 1 wherein the eyepiece optical system 5 and diffusing surface 11 are each configured in an annular shape. The visual display apparatus 1 wherein the eyepiece optical system 5 and diffusing surface 11 are each configured in an annular shape is designed such that the viewer s face is inserted through the middle space of the annular eyepiece optical system 5 and diffusing surface 11 so that a 360° image can be observed.

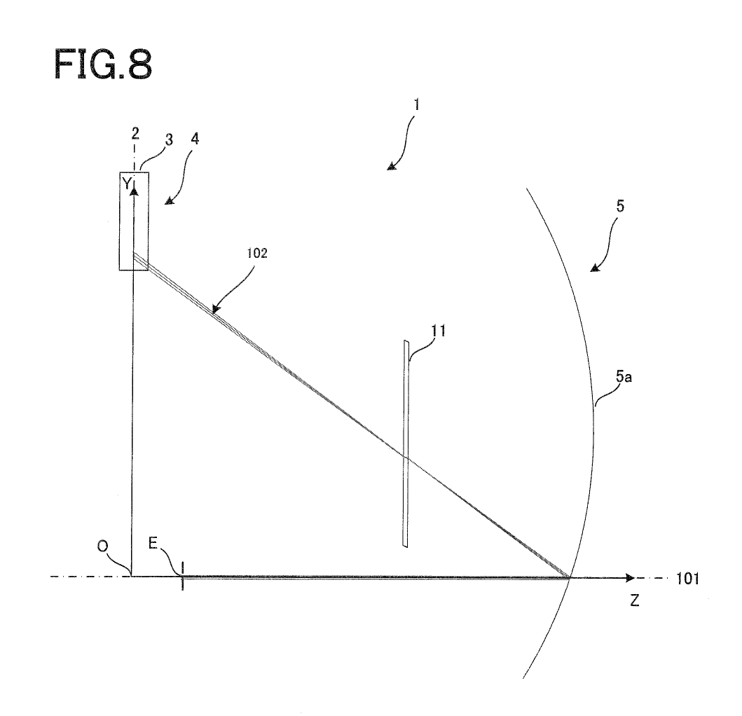

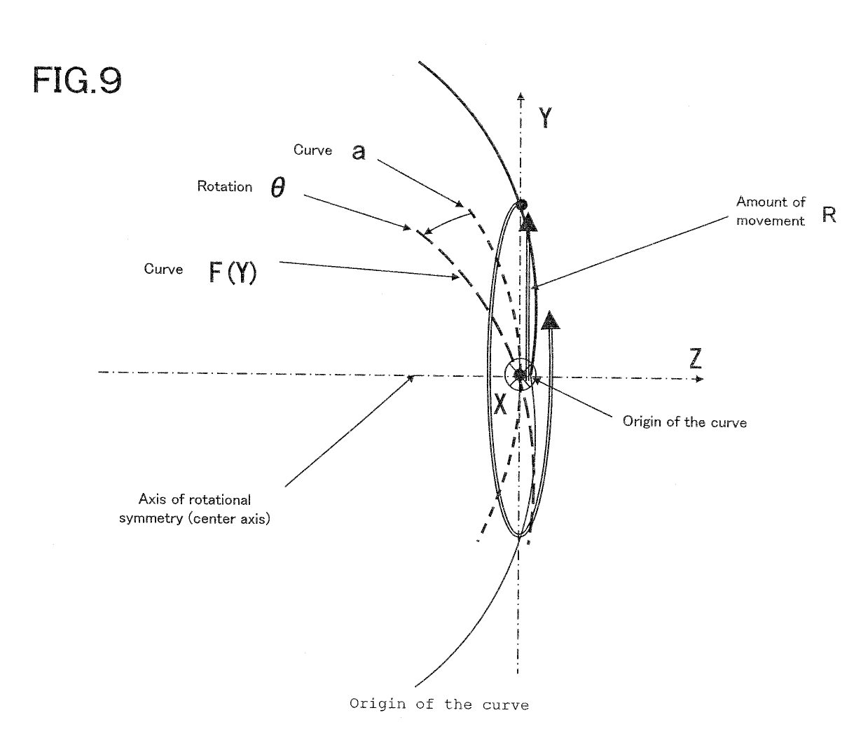

The optical system of the visual display apparatus 1 is now explained with reference to several examples. There will be the constituting parameters of these examples set out later, which are based on the results of back ray tracing wherein, as shown in FIG. 8 as an example, a light ray passing through the entrance pupil E of the eyepiece optical system 5 defined by a viewer s observation position and traveling toward the image display device 3 arrives at the image display device 3 through the eyepiece optical system 5 and the projection optical system 4 in this order.

Referring here to the coordinate system involved, as shown typically in FIG. 8, the origin O of the decentered optical surface of a decentered optical system is defined by a point of intersection O of the visual axis 101 that connects the entrance pupil E of the eyepiece optical system 5 with the eyepiece optical system 5 with the optical axis 2 of the projection optical system 4, the Y-axis positive direction is defined by a direction extending from the origin O of the optical axis 2 toward the image display device 3, and the Y-Z plane is defined by a plane within the sheet surface of FIG. 8. Then, the Z-axis positive direction is defined by the right direction from the origin O of FIG. 8, and the X-axis positive direction is defined by an axis that forms a right-handed orthogonal coordinate system with the Y- and Z-axis.

Given to each decentered surface are the amount of decentration of the coordinate system—on which that surface is defined—from the center of the origin of the optical system (X, Y and Z in the X-, Y- and Z-axis directions) and the angles (α, β, γ (°)) of tilt of the coordinate system for defining each surface about the X-, Y- and Z-axes of the coordinate system defined on the origin of the optical system. It is here to be noted that the positive α and β mean clockwise rotation with respect to the positive directions of the respective axes, and the positive γ means clockwise rotation with respect to the positive direction of the Z-axis. Referring to the α, β, γ rotation of the center axis of a certain surface, the coordinate system for defining each surface is first α rotated counterclockwise about the X-axis of the coordinate system defined on the origin of the coordinate system defined on the origin of the optical system. Then, it is β rotated counterclockwise about the Y-axis of the thus rotated, new coordinate system, and finally γ rotated clockwise about the Z-axis of the thus rotated, new another coordinate system.

When a specific surface of the optical function surfaces forming the optical system of each example and the subsequent surface form together a coaxial optical system, there is a surface-to-surface spacing given. Besides, the radii of curvature of the surfaces, and the refractive indices and Abbe constants of the media are given as usual.

The extended rotation free-form surface used herein is a rotationally symmetric surface given by the following definition.

In the first place, as shown in FIG. 9, there is the following curve (a) determined that passes through the origin on the Y-Z coordinate surface.

Z=(Y²/RY)/[1+{1−(C₁+1)Y²/RY²}^{1/2}]+C₂Y+C₃Y²+C₄Y³+C₅Y⁴+C₆Y⁵+C₇Y⁶+ . . . +C₂₁Y²⁰+ . . . +Cₙ₊₁Yⁿ+ . . . (a)

Then, this curve (a) is rotated through an angle θ (°) into a curve F(Y) provided that counterclockwise rotation about the X-axis positive direction is taken as positive. This curve F(Y), too, passes through the origin on the Y-Z coordinate surface.

That curve F(Y) is then translated by a distance R in the Y-positive direction (in the Y-negative direction in the case of minus), after which the translated curve is rotated about the Z-axis into a rotationally symmetric surface that is here defined as an extended rotation free-form surface.

As a consequence, the extended rotation free-form surface becomes a free-form surface (free-form curve) in the Y-Z plane, and a circle having a radius |R| in the X-Y plane.

From this definition, the Z-axis becomes the axis (axis of rotational symmetry) of the extended rotation free-form surface.

Here RY is the radius of curvature of the spherical term in the Y-Z section, C₁ is the conic constant, and C₂, C₃, C₄, C₅ . . . are the aspheric coefficients of first-, second-, third-, fourth- . . . orders.

It is here to be noted that the conical surface having the Z-axis at the center axis 2 is given as one of the extended rotation free-form surface provided that RY=∞; C₁, C₂, C₃, C₄, C₅, . . . =0; θ=the angle of inclination of the conical surface; and R=(the radius of the base in the X-Z plane).

The surface shape of the free-form surface is defined by the following formula (b). Note here that the axis of the free-form surface is given by the Z-axis of that defining formula.

$$Z = ( {r}^{2} / R ) / [ 1 + \sqrt{ } \{ 1 - ( 1 + k ) {( r / R )}^{2} \} ] + {\sum }_{j = 1}^{∞} {C}_{j} {X}^{m} {Y}^{n} \qquad ( b )$$

In formula (b) here, the first term is the spherical term and the second term is the free-form surface term.

In the spherical term,

R is the radius of curvature of the vertex,

k is the conic constant, and

r=√(X²+Y²).

The free-form surface term is

⁶⁶ΣCjX^{m}Yⁿ

j=1

=C₁

+C₂X+C₃Y

+C₄X²+C₅XY+C₆Y²

+C₇X³+C₈X²Y+C₉XY²+C₁₀Y³

+C₁₁X⁴+C₁₂X³Y+C₁₃X²Y²+C₁₄XY³+C₁₅Y⁴

+C₁₆X⁵+C₁₇X⁴Y+C₁₈X³Y²+C₁₉X²Y³+C₂₀XY⁴+C₂₁Y⁵

+C₂₂X⁶+C₂₃X⁵Y+C₂₄X⁴Y²+C₂₅X³Y³+C₂₆X²Y⁴+C₂₇XY⁵+C₂₈Y⁶

+C₂₉X⁷+C₃₀X⁶Y+C₃₁X⁵Y²+C₃₂X⁴Y³+C₃₃X³Y⁴+C₃₄X²Y⁵+C₃₅XY⁶+C₃₆Y⁷

Here Cⱼ (j is an integer of 1 or greater) is a coefficient.

In general, the aforesaid free-form surface has no plane of symmetry at both the X-Z plane and the Y-Z plane. However, by reducing all the odd-numbered terms for X down to zero, that free-form surface can have only one plane of symmetry parallel with the Y-Z plane. For instance, this may be achieved by reducing down to zero the coefficients for the terms C₂, C₅, C₇, C₉, C₁₂, C₁₄, C₁₆, C₁₈, C₂₀, C₂₃, C₂₅, C₂₇, C₂₉, C₃₁, C₃₃, C₃₅, . . . in the above defining formula (b).

By reducing all the odd-numbered terms for Y down to zero, the free-form surface can have only one plane of symmetry parallel with the X-Z plane. For instance, this may be achieved by reducing down to zero the coefficients for the terms C₃, C₅, C₈, C₁₀, C₁₂, C₁₄, C₁₇, C₁₉, C₂₁, C₂₃, C₂₅, C₂₇, C₃₀, C₃₂, C₃₄, C₃₆, . . . in the above defining formula.

If any one of the directions of the aforesaid plane of symmetry is used as the plane of symmetry and decentration is implemented in a direction corresponding to that, for instance, the direction of decentraton of the optical system with respect to the plane of symmetry parallel with the Y-Z plane is set in the Y-axis direction and the direction of dencentration of the optical system with respect to the plane of symmetry parallel with the X-Z plane is set in the X-axis direction, it is then possible to improve productivity while, at the same time, making effective correction of rotationally asymmetric aberrations occurring from decentration.

The aforesaid defining formula (b) is given for the sake of illustration alone as mentioned above: the feature of the invention is that by use of the rotationally asymmetric plane having only one plane of symmetry, it is possible to correct rotationally asymmetric aberrations occurring from decentration while, at the same time, improving productivity. It goes without saying that the same advantages are achievable even with any other defining formulae.

It is here noted that the term with respect to the free-form surface about which no data are given is zero. For the index of refraction, d-line (of 587.56 nm wavelength) refractive indices are given. Length is given in mm. As described above, the decentration of each surface is indicated in terms of the amount of decentration from the reference surface.

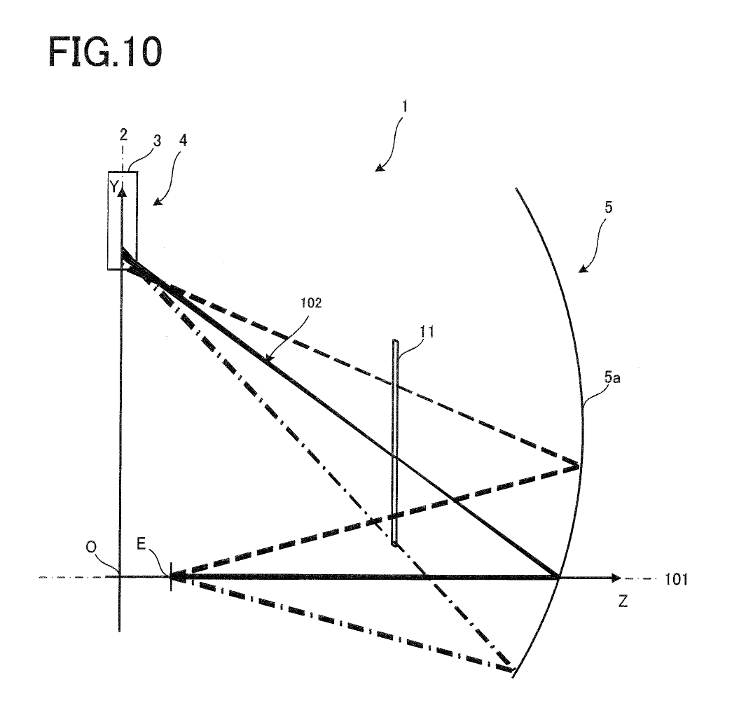

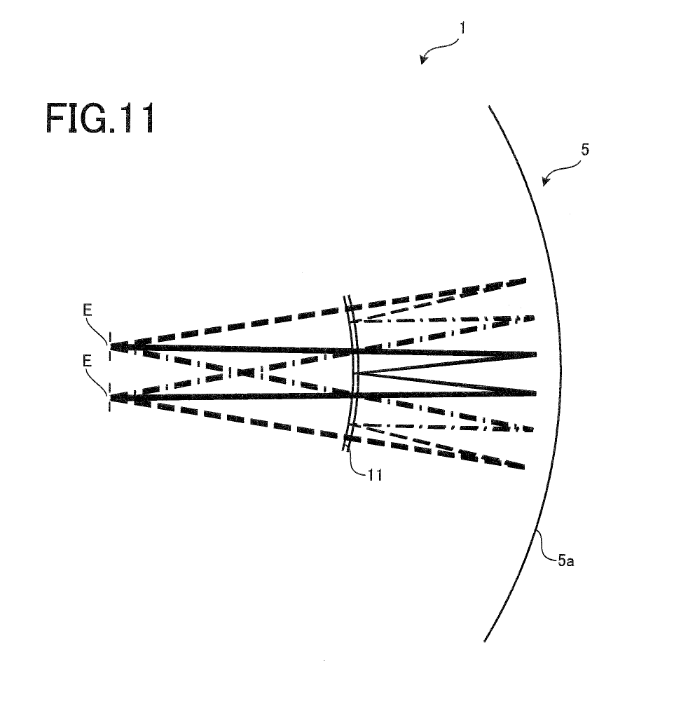

FIG. 10 is illustrative in section of the visual display apparatus 1 according to Example 1, as taken along the optical axis 2 of the projection optical system 4, and FIG. 11 is a plan view of FIG. 10. It is here to be noted that in FIG. 11 the projection optical system 4 is left out or not shown.

Example 1 is directed to the visual display apparatus 1 built up of the image display device 3, the projection optical system 4 for projection of an image displayed on the image display device 3, the eyepiece optical system 5 of positive reflecting power that uses an image coming from afar as the image to be projected from the projection optical system 4, and the cylindrical or conical diffusing surface 11 located near the image projected from the projection optical system 4, wherein the image projected from the projection optical system 4 is located in such a way as to draw a circular arc at any position in the plane orthogonal to the optical axis 2 of the projection optical system 4.

The eyepiece optical system 5 comprises an eyepiece reflecting surface 5a having positive power and made up of a spherical surface. It is here to be noted that through the eyepiece optical system 5 a virtual image long way off can be seen as an image.

The diffusing surface 11 is made up of a cylindrical surface, and the image projected from the projection optical system 4 is projected in a cylindrical or conical shape and near the diffusing surface 11.

The projection optical system 4 comprises the image display device 3.

The visual axis 101 extending in front of the viewer or through the center of the observation angle of view is orthogonal to the optical axis 2 of the projection optical system 4.

Referring here to an optical path A, a light beam leaving an entrance pupil E is reflected at the eyepiece reflecting surface 5a of the eyepiece optical system 5, and imaged intermediately at the diffusing surface 11, upon ray back tracing. A light beam leaving the diffusing surface 11 enters the projection optical system 4 where it is imaged at a radially given position off the optical axis 2 of the image display device 3.

The specifications of Example 1 are vertically 30.000° in terms of the angle of view.

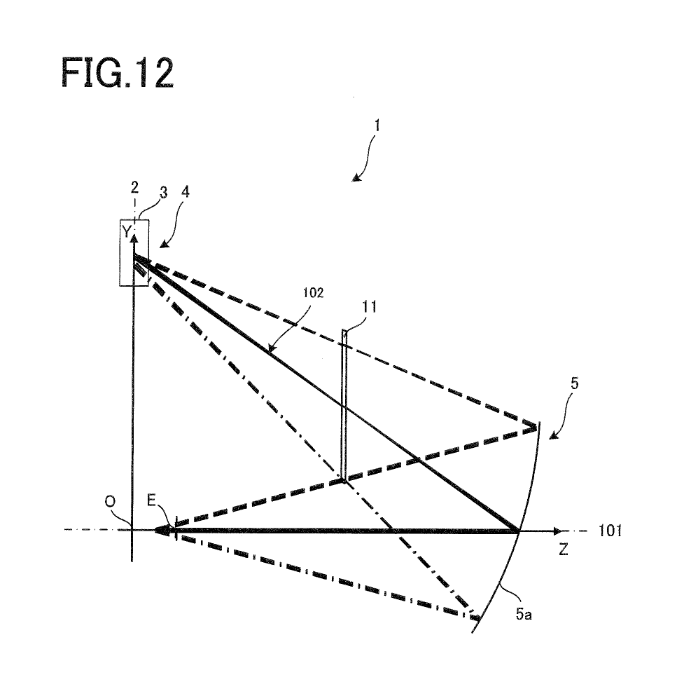

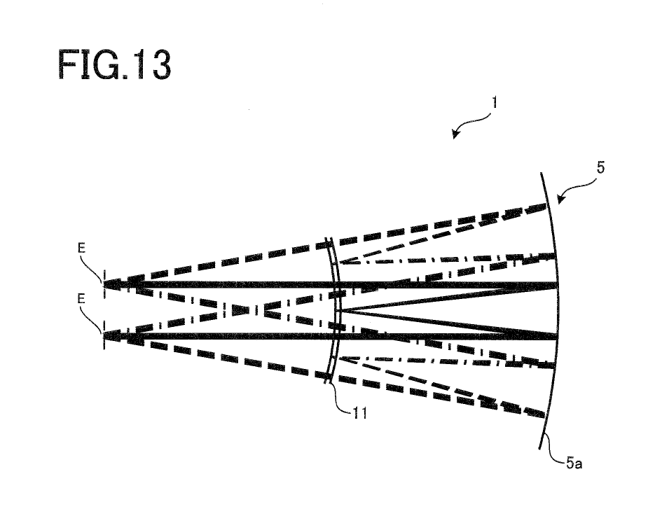

FIG. 12 is illustrative in section of the visual display apparatus 1 according to Example 2, as taken along the optical axis 2 of the projection optical system 4, and FIG. 13 is a plan view of FIG. 12. It is here to be noted that in FIG. 13 the projection optical system 4 is left out or not shown.

Example 2 is directed to the visual display apparatus 1 built up of the image display device 3, the projection optical system 4 for projection of an image displayed on the image display device 3, the eyepiece optical system 5 of positive reflecting power that uses an image coming from afar as the image to be projected from the projection optical system 4, and the cylindrical or conical diffusing surface 11 located near the image projected from the projection optical system 4, wherein the image projected from the projection optical system 4 is located in such a way as to draw a circular arc at any position in the plane orthogonal to the optical axis 2 of the projection optical system 4.

The eyepiece optical system 5 comprises an eyepiece reflecting surface 5a having positive power and made up of a toric surface (ERFS). It is here to be noted that through the eyepiece optical system 5 a virtual image long way off can be seen as an image.

The diffusing surface 11 is made up of a cylindrical surface, and an image projected from the projection optical system 4 is projected in a cylindrical or conical shape and near the diffusing surface 11.

The projection optical system 4 comprises the image display device 3.

The visual axis 101 extending in front of the viewer or through the center of the observation angle of view is orthogonal to the optical axis 2 of the projection optical system 4.

Referring here to a light path A, a light beam leaving an entrance pupil E is reflected at the eyepiece reflecting surface 5a of the eyepiece optical system 5, and imaged intermediately at the diffusing surface 11, upon ray back tracing. A light beam leaving the diffusing surface 11 enters the projection optical system 4 where it is imaged at a radially given position off the optical axis 2 of the image display device 3.

The specifications of Example 2 are vertically 30.000° in terms of the angle of view.

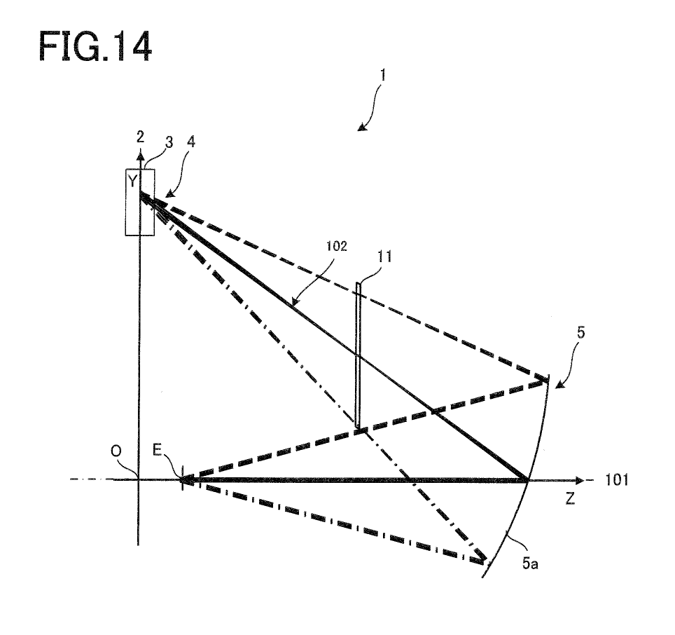

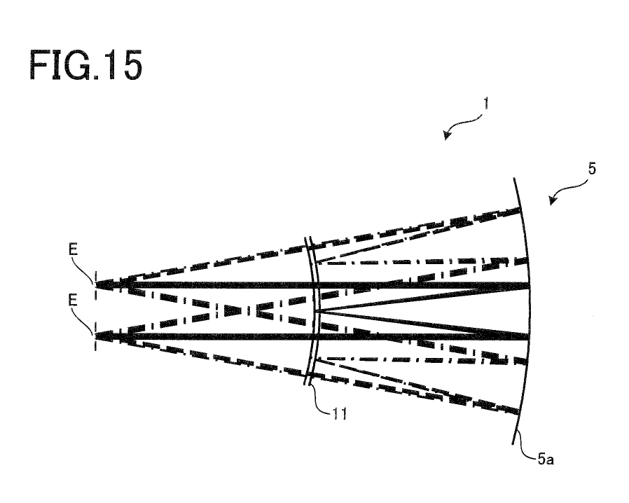

FIG. 14 is illustrative in section of the visual display apparatus 1 according to Example 3, as taken along the optical axis 2 of the projection optical system 4, and FIG. 15 is a plan view of FIG. 14. It is here to be noted that in FIG. 15 the projection optical system 4 is left out or not shown.

Example 3 is directed to the visual display apparatus 1 built up of the image display device 3, the projection optical system 4 for projection of an image displayed on the image display device 3, the eyepiece optical system 5 of positive reflecting power that uses an image coming from afar as an image to be projected from the projection optical system 4, and the cylindrical or conical diffusing surface 11 located near the image projected from the projection optical system 4, wherein the image projected from the projection optical system 4 is located in such a way as to draw a circular arc at any position in the plane orthogonal to the optical axis 2 of the projection optical system 4.

The eyepiece optical system 5 comprises an eyepiece reflecting surface 5a having positive power and made up of an extended rotation freeform surface (ERFS). It is here to be noted that through the eyepiece optical system 5 a virtual image long way off can be seen as an image.

The diffusing surface 11 is made up of a cylindrical surface, and an image projected from the projection optical system 4 is projected in a cylindrical or conical shape and near the diffusing surface 11.

The projection optical system 4 comprises the image display device 3.

The visual axis 101 extending in front of the viewer or through the center of the observation angle of view is orthogonal to the optical axis 2 of the projection optical system 4.

Referring here to an optical path A, a light beam leaving an entrance pupil E is reflected at the eyepiece reflecting surface 5a of the eyepiece optical system 5, and imaged intermediately at the diffusing surface 11, upon ray back tracing. A light beam leaving the diffusing surface 11 enters the projection optical system 4 where it is imaged at a radially given position off the optical axis 2 of the image display device 3.

The specifications of Example 3 are vertically 30.000° in terms of the angle of view.

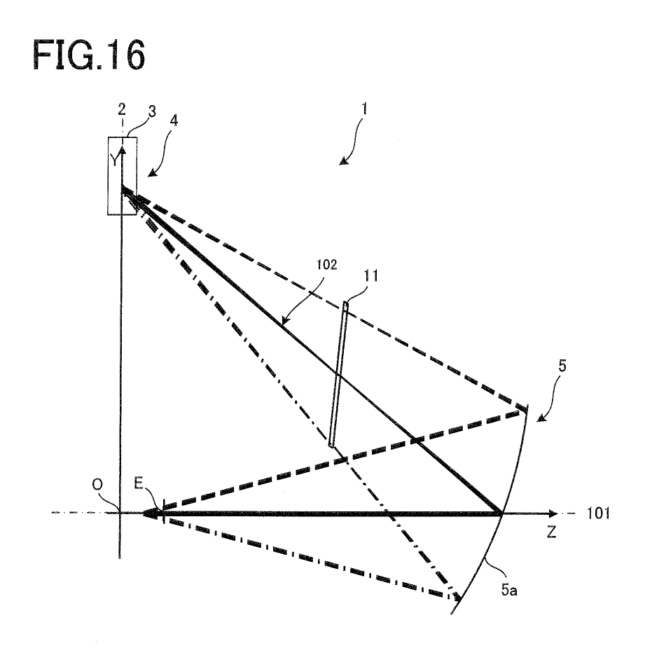

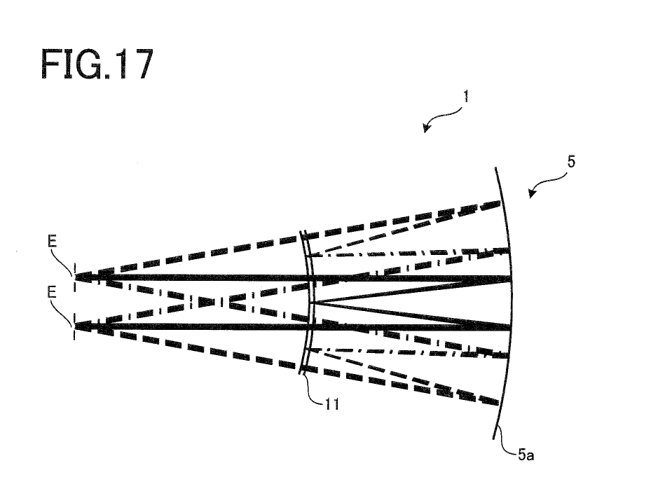

FIG. 16 is illustrative in section of the visual display apparatus 1 according to Example 4, as taken along the optical axis 2 of the projection optical system 4, and FIG. 17 is a plan view of FIG. 16. It is here to be noted that in FIG. 17 the projection optical system 4 is left out or not shown.

Example 4 is directed to the visual display apparatus 1 comprised of the image display device 3, the projection optical system 4 for projection of an image displayed on the image display device 3, the eyepiece optical system 5 of positive reflecting power that uses an image coming from afar as an image to be projected from the projection optical system 4, and the cylindrical or conical diffusing surface 11 located near the image projected from the projection optical system 4, wherein the image projected from the projection optical system 4 is located in such a way as to draw a circular arc at any position in the plane orthogonal to the optical axis 2 of the projection optical system 4.

The eyepiece optical system 5 comprises an eyepiece reflecting surface 5a having positive power and made up of an extended rotation free-form surface. It is here to be noted that through the eyepiece optical system 5 an image long way off can be seen as an image.

The diffusing surface 11 is made up of an extended rotation free-form surface, and an image projected from the projection optical system 4 is projected in a cylindrical or conical shape and near the diffusing surface 11.

The projection optical system 4 comprises the image display device 3.

The visual axis 101 extending in front of the viewer or through the center of the observation angle of view is orthogonal to the optical axis 2 of the projection optical system 4.

Referring here to a light path A, a light beam leaving an entrance pupil E is reflected at the eyepiece reflecting surface 5a of the eyepiece optical system 5, and imaged intermediately at the diffusing surface 11, upon ray back tracing. A light beam leaving the diffusing surface 11 enters the projection optical system 4 where it is imaged at a radially given position off the optical axis 2 of the image display device 3.

The specifications of Example 4 are vertically 30.000° in terms of the angle of view.

Set out below are the constituting parameters in Examples 1 to 4 given above. It is here to be noted that ERFS and FFS in the following tables stand for the extended rotation free-form surface and the free-form surface, respectively. It is also to be noted that data on the projection optical system 4 will be omitted.

### Example 1

| | | Surface-to- | | Refrac- | Abbe |
|---|---|---|---|---|---|
| Surface | Radius of | Surface | | tive | Con- |
| No. | Curvature | Spacing | Decentration | Index | stant |
| Object | ∞ | −1850.00 | | | |
| Surface | | | | | |
| 1 | ∞ | 0.00 | Decentration (1) | | |
| | (Entrance | | | | |
| | Pupil) | | | | |
| 2 | −500.00 | 0.00 | Decentration (2) | | |
| | (RE) | | | | |
| 3 | Cylindrical | 0.00 | Decentration (3) | 1.5163 | 64.1 |
| | Surface [1] | | | | |
| 4 | Cylindrical | 0.00 | Decentration (4) | | |
| | Surface [2] | | | | |
| 5 | ∞ | 0.00 | Decentration (5) | | |
| | (Exit Pupil) | | | | |
| Image | Cylindrical | 0.00 | Decentration (4) | | |
| Surface | Surface [2] | | | | |

Cylindrical Surface [1]

| | |
|---|---|
| RY | ∞ |
| Rx | −300 |

Cylindrical Surface [2]

| | |
|---|---|
| RY | ∞ |
| Rx | −295 |

Decentration [1]

| | | | | | |
|---|---|---|---|---|---|
| X | 0.00 | Y | 0.00 | Z | 55.00 |
| α | 0.00 | β | 0.00 | γ | 0.00 |

Decentration [2]

| | | | | | |
|---|---|---|---|---|---|
| X | 0.00 | Y | 154.37 | Z | 500.00 |
| α | 0.00 | β | 0.00 | γ | 0.00 |

Decentration [3]

| | | | | | |
|---|---|---|---|---|---|
| X | 0.00 | Y | 142.13 | Z | 300.00 |
| α | 0.00 | β | 0.00 | γ | 0.00 |

Decentration [4]

| | | | | | |
|---|---|---|---|---|---|
| X | 0.00 | Y | 144.23 | Z | 295.00 |
| α | 0.00 | β | 0.00 | γ | 0.00 |

Decentration [5]

| | | | | | |
|---|---|---|---|---|---|
| X | 0.00 | Y | 344.77 | Z | 0.00 |
| α | 0.00 | β | 0.00 | γ | 0.00 |

### Example 2

| | | Surface-to- | | Refrac- | Abbe |
|---|---|---|---|---|---|
| Surface | Radius of | Surface | | tive | Con- |
| No. | Curvature | Spacing | Decentration | Index | stant |
| Object | ∞ | ∞ | | | |
| Surface | | | | | |
| 1 | ∞ | 0.00 | Decentration (1) | | |
| | (Entrance | | | | |
| | Pupil) | | | | |
| 2 | ERFS [1] | 0.00 | | | |
| | (RE) | | | | |
| 3 | Cylindrical | 0.00 | Decentration (2) | 1.5163 | 64.1 |
| | Surface [1] | | | | |
| 4 | Cylindrical | 0.00 | Decentration (3) | | |
| | Surface [2] | | | | |
| 5 | ∞ | 0.00 | Decentration (4) | | |
| | (Exit Pupil) | | | | |
| Image | Cylindrical | 0.00 | Decentration (3) | | |
| Surface | Surface [2] | | | | |

ERFS[1]

| | |
|---|---|
| RY | −532.29 |
| θ | −17.54 |
| R | 475.00 |

Cylindrical Surface [1]

| | | |
|---|---|---|
| X-direction | Radius of Curvature | 262.21 |
| Y-direction | Radius of Curvature | ∞ |

Cylindrical Surface [2]

| | | |
|---|---|---|
| X-direction | Radius of Curvature | 257.21 |
| Y-direction | Radius of Curvature | ∞ |

Decentration [1]

| | | | | | |
|---|---|---|---|---|---|
| X | 0.00 | Y | 0.00 | Z | 30.00 |
| α | 0.00 | β | 0.00 | γ | 0.00 |

Decentration [2]

| | | | | | |
|---|---|---|---|---|---|
| X | 0.00 | Y | 149.74 | Z | 262.21 |
| α | 0.00 | β | 0.00 | γ | 0.00 |

Decentration [3]

| | | | | | |
|---|---|---|---|---|---|
| X | 0.00 | Y | 151.79 | Z | 257.21 |
| α | 0.00 | β | 0.00 | γ | 0.00 |

Decentration [4]

| | | | | | |
|---|---|---|---|---|---|
| X | 0.00 | Y | 344.77 | Z | 0.00 |
| α | 0.00 | β | 0.00 | γ | 0.00 |

### Example 3

| | | Surface-to- | | Refrac- | Abbe |
|---|---|---|---|---|---|
| Surface | Radius of | Surface | | tive | Con- |
| No. | Curvature | Spacing | Decentration | Index | stant |
| Object | ∞ | ∞ | | | |
| Surface | | | | | |
| 1 | ∞ | 0.00 | Decentration (1) | | |
| | (Entrance | | | | |
| | Pupil) | | | | |
| 2 | ERFS [1] | 0.00 | | | |
| | (RE) | | | | |
| 3 | Cylindrical | 0.00 | Decentration (2) | 1.5163 | 64.1 |
| | Surface [1] | | | | |
| 4 | Cylindrical | 0.00 | Decentration (3) | | |
| | Surface [2] | | | | |
| 5 | ∞ | 0.00 | Decentration (4) | | |
| | (Exit Pupil) | | | | |
| Image | Cylindrical | 0.00 | Decentration (3) | | |
| Surface | Surface [2] | | | | |

ERFS[1]

| | |
|---|---|
| RY | −516.77 |
| θ | −18.00 |
| R | 475.00 |
| C4 | 1.0918E−007 |

Cylindrical Surface [1]

| | | |
|---|---|---|
| X-direction | Radius of Curvature | −269.26 |
| Y-direction | Radius of Curvature | ∞ |

Cylindrical Surface [2]

| | | |
|---|---|---|
| X-direction | Radius of Curvature | −264.26 |
| Y-direction | Radius of Curvature | ∞ |

Decentration [1]

| | | | | | |
|---|---|---|---|---|---|
| X | 0.00 | Y | 0.00 | Z | 50.00 |
| α | 0.00 | β | 0.00 | γ | 0.00 |

Decentration [2]

| | | | | | |
|---|---|---|---|---|---|
| X | 0.00 | Y | 149.73 | Z | 269.26 |
| α | 0.00 | β | 0.00 | γ | 0.00 |

Decentration [3]

| | | | | | |
|---|---|---|---|---|---|
| X | 0.00 | Y | 151.83 | Z | 264.26 |
| α | 0.00 | β | 0.00 | γ | 0.00 |

Decentration [4]

| | | | | | |
|---|---|---|---|---|---|
| X | 0.00 | Y | 344.77 | Z | 0.00 |
| α | 0.00 | β | 0.00 | γ | 0.00 |

### Example 4

| | | Surface-to- | | Refrac- | Abbe |
|---|---|---|---|---|---|
| Surface | Radius of | Surface | | tive | Con- |
| No. | Curvature | Spacing | Decentration | Index | stant |
| Object | ∞ | ∞ | | | |
| Surface | | | | | |
| 1 | ∞ | 0.00 | Decentration (1) | | |
| | (Entrance | | | | |
| | Pupil) | | | | |
| 2 | ERFS [1] | 0.00 | | | |
| | (RE) | | | | |
| 3 | ERFS [2] | 0.00 | Decentration (2) | 1.5163 | 64.1 |
| 4 | ERFS [3] | 0.00 | Decentration (3) | | |
| 5 | ∞ | 0.00 | Decentration (4) | | |
| | (Exit Pupil) | | | | |
| Image | ERFS [3] | 0.00 | Decentration (3) | | |
| Surface | | | | | |

ERFS[1]

| | |
|---|---|
| RY | −549.70 |
| θ | −20.06 |
| R | 475.00 |
| C4 | 1.0566E−007 |

ERFS[2]

| | |
|---|---|
| RY | ∞ |
| θ | −5.70 |
| R | 273.42 |

ERFS[3]

| | |
|---|---|
| RY | ∞ |
| θ | −5.70 |
| R | 268.42 |

Decentration [1]

| | | | | | |
|---|---|---|---|---|---|
| X | 0.00 | Y | 0.00 | Z | 30.00 |
| α | 0.00 | β | 0.00 | γ | 0.00 |

Decentration [2]

| | | | | | |
|---|---|---|---|---|---|
| X | 0.00 | Y | 170.11 | Z | 0.00 |
| α | 0.00 | β | 0.00 | γ | 0.00 |

Decentration [3]

| | | | | | |
|---|---|---|---|---|---|
| X | 0.00 | Y | 172.72 | Z | 0.00 |
| α | 0.00 | β | 0.00 | γ | 0.00 |

Decentration [4]

| | | | | | |
|---|---|---|---|---|---|
| X | 0.00 | Y | 400.00 | Z | −30.00 |
| α | 0.00 | β | 0.00 | γ | 0.00 |

It is here to be noted that in Examples 1 to 4, only a light ray in a 20° horizontal direction is traced; however, the inventive apparatus, because of being a rotationally symmetric optical system, enables a 360° observation angle of view to be obtained without any modification to it.

Diffusion at the diffusing surface 11 is left out of ray tracing.

Data on the interpupillary distance of both eyes of the viewer are left out; however, it is actually traced at 50 mm in the optical path diagram in the horizontal section.

For ray tracing, ray back tracing is implemented from the eyeball of the viewer toward the exit pupil of the projection optical system.

What is claimed is:

1. A visual display apparatus comprising:
an image display device,
a projection optical system for projection of an image displayed on the image display device,
an eyepiece optical system of positive reflecting power that uses an image coming from afar as an image projected from the projection optical system, and
a cylindrical or conical diffusing surface located near an image projected from the projection optical system: wherein
the image projected from the projection optical system is located in such a way as to draw a circular arc at any position in a plane orthogonal to an optical axis of the projection optical system.

2. The visual display apparatus according to claim 1, wherein
the image display device displays an annular or arcing image.

3. The visual display apparatus according to claim 1, wherein
a visual axis extending in front of a viewer or through a center of an observation angle of view crosses the optical axis of the projection optical system.

4. The visual display apparatus according to claim 1, wherein
a visual axis extending in front of a viewer or through a center of an observation angle of view is orthogonal to the axis of the projection optical system.

5. The visual display apparatus according to claim 1, wherein
the eyepiece optical system is located at a tilt to the visual axis extending in front of a viewer or through the center of an observation angle of view.

6. The visual display apparatus according to claim 1, wherein
the image projected from the projection optical system is located at a tilt to a center chief ray.

7. The visual display apparatus according to claim 1, wherein
the diffusing surface is located at a tilt to a center chief ray.

8. The visual display apparatus according to claim 1, wherein
the diffusing surface is in a linear shape in a meridional section.

9. The visual display apparatus according to claim 1, wherein
the projection optical system is incapable of projecting images on an optical axis.

10. The visual display apparatus according to claim 1, wherein
the eyepiece optical system is a spherical surface.

11. The visual display apparatus according to claim 1, wherein
the eyepiece optical system is a toric surface.

12. The visual display apparatus according to claim 1, wherein
the eyepiece optical system is a part of an elliptical surface having two focuses: one defined by an exit pupil position of the projection optical system, and the other by an eyeball position of a viewer.

13. The visual display apparatus according to claim 1, wherein
the eyepiece optical system is a free-form surface.

14. The visual display apparatus according to claim 1, wherein
the eyepiece optical system is an extended rotation free-form surface.
